(19) United States
(12) Patent Application Publication
(10) Pub. No.: US 2019/0339858 A1
(43) Pub. Date: Nov. 7, 2019

(54) Method and apparatus for adjusting virtual key of mobile terminal

(71) Applicant: AAC Technologies Pte. Ltd., Singapore City (SG)

(72) Inventors: Xiuyue Wang, Shenzhen (CN); Yulei Zhang, Shenzhen (CN); Dongping Deng, Shenzhen (CN)

(21) Appl. No.: 16/236,509

(22) Filed: Dec. 30, 2018

(30) Foreign Application Priority Data
May 7, 2018 (CN) 201810427135.4

(51) Int. Cl. G06F 3/0488; G06F 3/041

(52) U.S. Cl. CPC G06F 3/04886; G06F 2203/04806; G06F 3/0418

(57) ABSTRACT

The embodiments of the present disclosure relate to the technical field of electronic devices and disclose a method and an apparatus for adjusting a virtual key of a mobile terminal. According to the present disclosure, a method for adjusting a virtual key of a mobile terminal includes: collecting first touch information within a non-virtual-key region; determining whether the first touch information satisfies a first predetermined adjustment condition; receiving second touch information within the virtual key region when it is determined that the first touch information satisfies the first predetermined adjustment condition; and adjusting the virtual key based on the second touch information. The method and apparatus for adjusting a virtual key of a mobile terminal can effectively prevent false triggering of the virtual key.

### CROSS-REFERENCE TO RELATED APPLICATIONS

The present application claims priority to Chinese Patent Application No. 201810427135.4, filed on May 7, 2018, the content of which is incorporated herein by reference in its entirety.

### TECHNICAL FIELD

The present disclosure relates to the technical field of electronic devices and, in particular, to a method and an apparatus for adjusting a virtual key of a mobile terminal.

### BACKGROUND

Virtual keys are opposed to hardware keys that exist physically. A virtual key refers to a virtual key image (referred to as a virtual key) that appears on a screen of a display device and imitates a physical key by means of software. While a virtual key image region is not a physical hardware key, it can be operated with different gestures and perform different functions according to its operation images displayed on a screen of an operating device, thereby providing functions similar to those of a physical hardware key. Virtual keys are widely used on displays of various devices such as personal computers, mobile terminals, industrial control computers and the like, to effectively avoid physical keys' disadvantages such as large space occupation, vulnerability to damages and difficulty to repair. Virtual keys can achieve the functions of the physical keys while having advantages such as low cost and simplicity to install, and thus become increasingly popular. In the related art, upon detecting a touch point within a virtual key region, a mobile terminal will respond to this trigger immediately to operate accordingly.

However, the inventors have realized at least the following problems in the related art. When a user touches a virtual key region unintentionally while using a mobile terminal, the mobile terminal will respond immediately, resulting in false triggering of a virtual region. Thus, there is a need for a novel method and a novel apparatus for adjusting a virtual key of a mobile terminal, capable of solving the above problem.

### BRIEF DESCRIPTION OF DRAWINGS

FIG. 1 is a flowchart illustrating a method for adjusting a virtual key of a mobile terminal according to a first embodiment of the present disclosure;

FIG. 2 is a flowchart illustrating a method for adjusting a virtual key of a mobile terminal according to a second embodiment of the present disclosure;

FIG. 3 is a flowchart illustrating a method for adjusting a virtual key of a mobile terminal according to a third embodiment of the present disclosure;

FIG. 4 is a schematic diagram showing operations according to the method for adjusting a virtual key of a mobile terminal in the third embodiment of the present disclosure;

FIG. 5 is a flowchart illustrating a method for adjusting a virtual key of a mobile terminal according to a fourth embodiment of the present disclosure;

FIG. 6 is a flowchart illustrating a method for adjusting a virtual key of a mobile terminal according to a fifth embodiment of the present disclosure;

FIG. 7 is a schematic diagram showing operations according to the method for adjusting a virtual key of a mobile terminal in the fifth embodiment of the present disclosure; and

FIG. 8 is a structural schematic diagram of an apparatus for adjusting a virtual key of a mobile terminal according to a sixth embodiment of the present disclosure.

### DESCRIPTION OF EMBODIMENTS

In the following, the embodiments of the present disclosure will be described in detail, such that the objects, solutions and advantages of the embodiments of the present disclosure will become more apparent. Many technical details are provided in these embodiments to facilitate better understanding of the present disclosure. However, it can be appreciated by those skilled in the art that the solutions of the present disclosure can be implemented without these technical details, e.g., based on various alternatives and modifications to the embodiments below.

A first embodiment of the present disclosure relates to a method for adjusting a virtual key of a mobile terminal. The mobile terminal includes a touch screen that is divided into a virtual key region and a non-virtual-key region. The essence of this embodiment consists in collecting first touch information within the non-virtual-key region; determining whether the first touch information satisfies a first predetermined adjustment condition; receiving second touch information within the virtual key region when it is determined that the first touch information satisfies the first predetermined adjustment condition; and adjusting the virtual key based on the second touch information. By receiving the second touch information within the virtual key region when it is determined that the first touch information satisfies the first predetermined adjustment condition, the mobile terminal can receive the second touch information within the virtual key region on purpose, rather than receiving the second touch information within the virtual key region in any cases. In the following, implementation details of a method for adjusting a virtual key of a mobile terminal according to this embodiment will be described, which are provided only for the purpose of illustration, rather than limiting the solution.

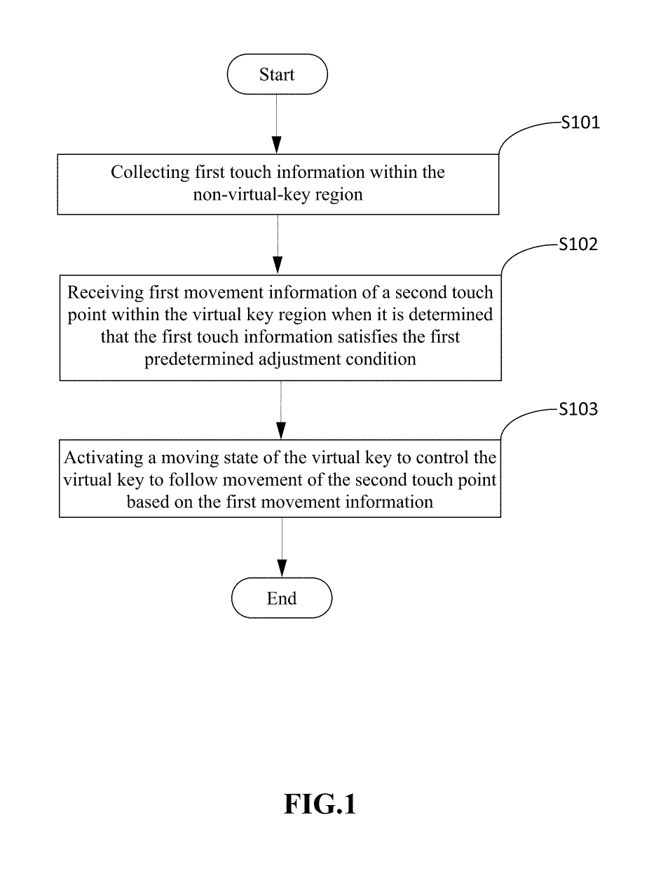

As shown in FIG. 1, a method for adjusting a virtual key of a mobile terminal according to this embodiment includes the following steps.

At S101, first touch information within the non-virtual-key region is collected.

In particular, in the step S101, the first touch information can be a first pressure value at a first touch point within the non-virtual-key region. Force sensors can be provided at four corners of the screen of the mobile terminal for sensing pressures and providing action feedbacks at three levels: tap, soft press and hard press.

It can be appreciated that the purpose of collecting the first touch information within the non-virtual-key region is to determine subsequently whether the first touch information satisfies a first predetermined adjustment condition, so as to determine that it is not a misoperation by a user. Hence, in this embodiment, the first touch information can be any information that can be used for determining that the user is operating the mobile terminal. For example, a capacitance value within the non-virtual-key region can be detected.

At S102, when it is determined that the first touch information satisfies the first predetermined adjustment condition, first movement information of a second touch point within the virtual key region is received.

In particular, in the step S102, the first movement information can be information indicating the movement of the second touch point within the virtual key region from a current position to a target position. A first predetermined pressure threshold can be preconfigured in the mobile terminal. When it is detected that the first pressure value is larger than or equal to the first predetermined pressure threshold, the first movement information of the second touch point within the virtual key region can be received. When the user is using the mobile terminal, a pressure normally applied to the non-virtual-key region is necessarily smaller than the first predetermined pressure threshold. Hence, it can be determined whether the user is to adjust the virtual key by determining whether the first pressure value is larger than or equal to the first predetermined pressure threshold.

It is to be noted that, in this embodiment, the first touch information can be information reflecting a change within the non-virtual-key region, e.g., a capacitance value within the non-virtual-key region, as an alternative to the first pressure value at the first touch point. A predetermined triggering capacitance value can be preconfigured in the mobile terminal. A first time length from the time at which the capacitance value within the non-virtual-key region changes to the time at which it reaches the predetermined triggering capacitance value is recorded. A parameter corresponding to the current virtual key triggering can be obtained from the first time length and compared with a parameter corresponding to a normal virtual key triggering, so as to determine whether the current triggering within the non-virtual-key region is a false triggering or not. When it is determined to be a false triggering, the first movement information of the second touch point within the virtual key region will not be received. It is to be noted that a preferred scheme for determining whether to receive the first movement information of the second touch point within the virtual key region based on the first time length and a predetermined key triggering parameter may include: determining whether the first time length is larger than a second time length included in the predetermined key triggering parameter; and if not, determining that the current virtual key triggering is a false triggering. The second time length, which is a time length for normally triggering a touch point in the non-virtual-key region, is necessarily smaller than the first time length, which is a time length for triggering the first touch point to operate the virtual key. Hence, it can be determined whether the current virtual key triggering is a false triggering by comparing these time lengths.

At S103, a moving state of the virtual key is activated to control the virtual key to follow movement of the second touch point based on the first movement information.

In particular, in the step S103, a moving trajectory of the virtual key is consistent with that of the second touch point. That is, when the user presses and drags the second touch point, the virtual key will move along the moving trajectory of the touch point. The user can move the virtual key to his/her desired position. The moving of the virtual key to a target position can be done according to an existing scheme. For example, the user can press and hold the virtual key, and drag it to the target position and release it. Alternatively, the user may select the virtual key by clicking it, superimpose it on a touch object, move it along with the touch object and select a target position by clicking the target position, so as to place the virtual key at the target position.

When compared with the related art, in the embodiment of the present disclosure, by collecting first touch information within the non-virtual-key region, determining whether the first touch information satisfies a first predetermined adjustment condition and receiving second touch information within the virtual key region, when detecting a touch point within the virtual key region, the mobile terminal will not blindly respond to the virtual key touch operation immediately. Only when a user has performed a particular operation in the non-virtual-key region, the second touch information within the virtual key region can be received and the user can continue operating in the virtual key region. The user cannot adjust the virtual key by operating in the virtual key region directly. In this way, it is possible to effectively prevent false triggering of the virtual key when the user touches the virtual key unintentionally.

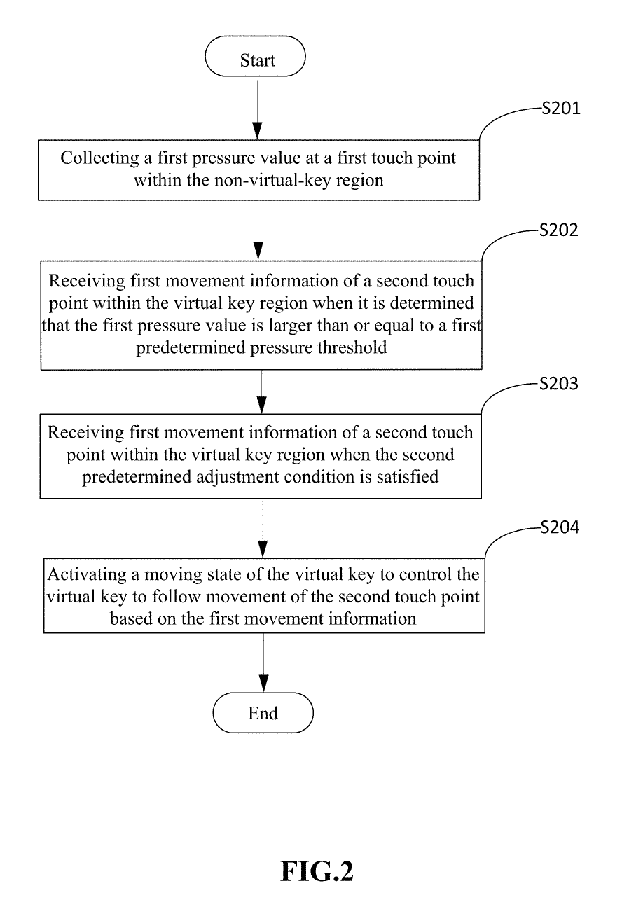

A second embodiment of the present disclosure relates to a method for adjusting a virtual key of a mobile terminal. The second embodiment makes improvements on the first embodiment in that the method further includes, prior to activating the moving state of the virtual key to control the virtual key to follow movement of the second touch point based on the first movement information: detecting whether the second touch information satisfies a second predetermined adjustment condition, and that the moving state of the virtual key is activated to control the virtual key to follow movement of the second touch point based on the first movement information when the second predetermined adjustment condition is satisfied. By detecting whether the second touch information satisfies the second predetermined adjustment condition before activating the moving state of the virtual key, it is possible to further prevent false triggering of the virtual key. As shown in FIG. 2, the method for adjusting a virtual key of a mobile terminal according to this embodiment includes the following steps.

At S201, a first pressure value at a first touch point within the non-virtual-key region is collected.

At S202, when it is determined that the first pressure value is larger than or equal to a first predetermined pressure threshold, it is detected whether second touch information satisfies a second predetermined adjustment condition.

In particular, in the step S202, the second touch information may further include a second pressure value at the second touch point. A second predetermined pressure threshold can be preconfigured in the mobile terminal. The operation of detecting whether the second touch information satisfies the second predetermined adjustment condition may include detecting whether the second pressure value is larger than or equal to the second predetermined pressure threshold.

It can be appreciated that the second predetermined pressure threshold in this embodiment may or may not be equal to the first predetermined pressure threshold in the first embodiment. They can be set by the user as desired.

At S203, when the second predetermined adjustment condition is satisfied, first movement information of a second touch point within the virtual key region is received.

In particular, in the step S203, when it is detected that the second pressure value is larger than or equal to the second predetermined pressure threshold, the first movement information of the second touch point within the virtual key region can be received. When the user is using the mobile terminal, a pressure normally applied to the virtual key region is necessarily smaller than the second predetermined pressure threshold. Hence, it can be determined whether the user is to adjust the virtual key by determining whether the second pressure value is larger than or equal to the second predetermined pressure threshold.

It is to be noted that, when a user is using the mobile terminal, the first pressure value within the non-virtual-key region may be too large for some reason, which causes the virtual key to be adjusted when the user does not want to adjust the virtual key. By further detecting whether a second pressure within the virtual key region is larger than or equal to a second predetermined pressure threshold, it is possible to further prevent false triggering of the virtual key, thereby ensuring that the virtual key will be adjusted only when the user needs to do so.

At S204, a moving state of the virtual key is activated to control the virtual key to follow movement of the second touch point based on the first movement information.

When compared with the related art, in the embodiment of the present disclosure, by collecting first touch information within the non-virtual-key region, determining whether the first touch information satisfies a first predetermined adjustment condition and receiving second touch information within the virtual key region, when detecting a touch point within the virtual key region, the mobile terminal will not blindly respond to the virtual key touch operation immediately. Only when a user has performed a particular operation in the non-virtual-key region, the second touch information within the virtual key region can be received and the user can continue operating in the virtual key region. The user cannot adjust the virtual key by operating in the virtual key region directly. In this way, it is possible to effectively prevent false triggering of the virtual key when the user touches the virtual key unintentionally.

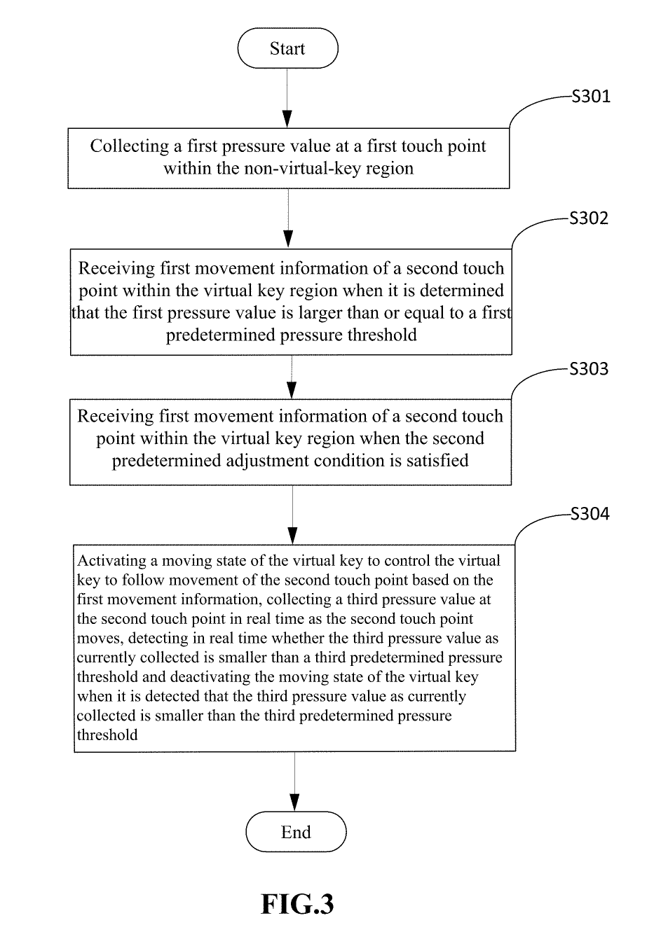

A third embodiment of the present disclosure relates to a method for adjusting a virtual key of a mobile terminal. The third embodiment makes improvements on the second embodiment in that the method further includes, subsequent to controlling the virtual key to follow movement of the second touch point based on the first movement information: collecting a third pressure value at the second touch point in real time as the second touch point moves and detecting in real time whether the third pressure value as currently collected is smaller than a third predetermined pressure threshold; and deactivating the moving state of the virtual key upon detecting that the third pressure value as currently collected is smaller than the third predetermined pressure threshold. By detecting the third pressure value at the second touch point in real time as the second touch point moves, the moving state of the virtual key can be deactivated immediately when the third pressure value is smaller than the third predetermined pressure threshold, such that the virtual key can be moved precisely to a target position desired by the user. As shown in FIG. 3, the method for adjusting a virtual key of a mobile terminal according to this embodiment includes the following steps.

At S301, a first pressure value at a first touch point within the non-virtual-key region is collected.

At S302, when it is determined that the first pressure value is larger than or equal to a first predetermined pressure threshold, it is detected whether second touch information satisfies a second predetermined adjustment condition.

At S303, when the second predetermined adjustment condition is satisfied, first movement information of a second touch point within the virtual key region is received.

The steps S301˜S303 in the third embodiment are substantially the same as the steps S201˜S203 in the second embodiment and details thereof will be omitted here for simplicity.

At S304, a moving state of the virtual key is activated to control the virtual key to follow movement of the second touch point based on the first movement information. A third pressure value at the second touch point is collected in real time as the second touch point moves. It is detected in real time whether the third pressure value as currently collected is smaller than a third predetermined pressure threshold. When it is detected that the third pressure value as currently collected is smaller than the third predetermined pressure threshold, the moving state of the virtual key is deactivated.

In particular, in the step S304, by detecting the third pressure value at the second touch point in real time as the second touch point moves, the moving state of the virtual key can be deactivated immediately when the third pressure value is smaller than the third predetermined pressure threshold, such that the virtual key can be moved precisely to a target position desired by the user.

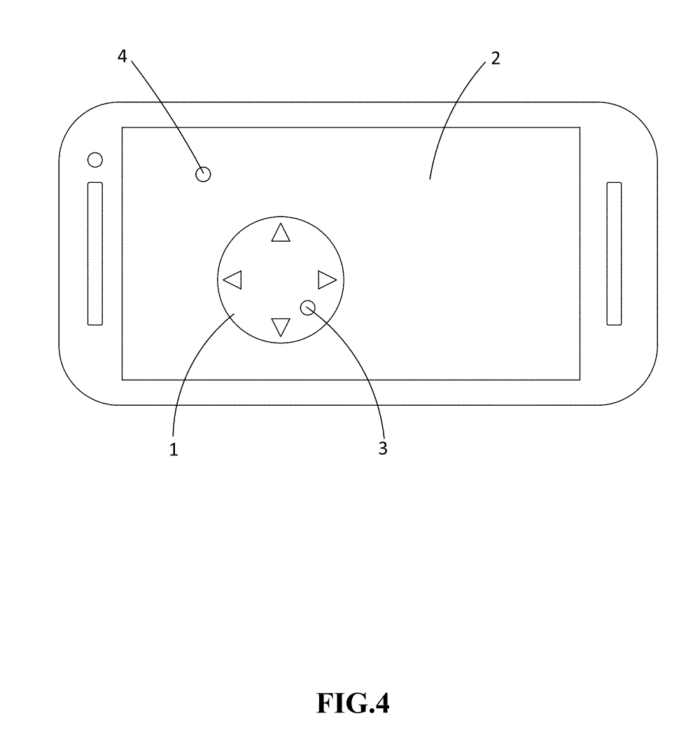

In order to facilitate better understanding of the present disclosure, an example will be given below to explain a method for adjusting a virtual key when the first predetermined pressure threshold, the second predetermined pressure threshold and the third predetermined pressure threshold are equal in this embodiment, as shown in FIG. 4.

(1) During operation, when two touch points are detected in the screen, one in the virtual key region 1 and the other in the non-virtual-key region 2, and the pressure values at the two points reach the pressure thresholds, respectively: the first pressure value P_{c1}>=the first predetermined pressure threshold Pᵥ and the second pressure value P_{c2}>=the second predetermined pressure threshold Pᵥ, the moving state of the virtual key 1 will be activated, waiting for a moving instruction.

(2) The second touch point 3 within the region of the virtual key 1 is pressed and dragged, such that the virtual key 1 moves along the moving trajectory of the second touch point 3.

(3) When the dragging completes and the virtual key is released at the pressing point 4. When P_{c2}<Pᵥ, the moving state of the virtual key 1 will be deactivated. The virtual key 1 stops moving and is fixed at the current position.

When compared with the related art, in the embodiment of the present disclosure, by collecting first touch information within the non-virtual-key region, determining whether the first touch information satisfies a first predetermined adjustment condition and receiving second touch information within the virtual key region, when detecting a touch point within the virtual key region, the mobile terminal will not blindly respond to the virtual key touch operation immediately. Only when a user has performed a particular operation in the non-virtual-key region, the second touch information within the virtual key region can be received and the user can continue operating in the virtual key region. The user cannot adjust the virtual key by operating in the virtual key region directly. In this way, it is possible to effectively prevent false triggering of the virtual key when the user touches the virtual key unintentionally.

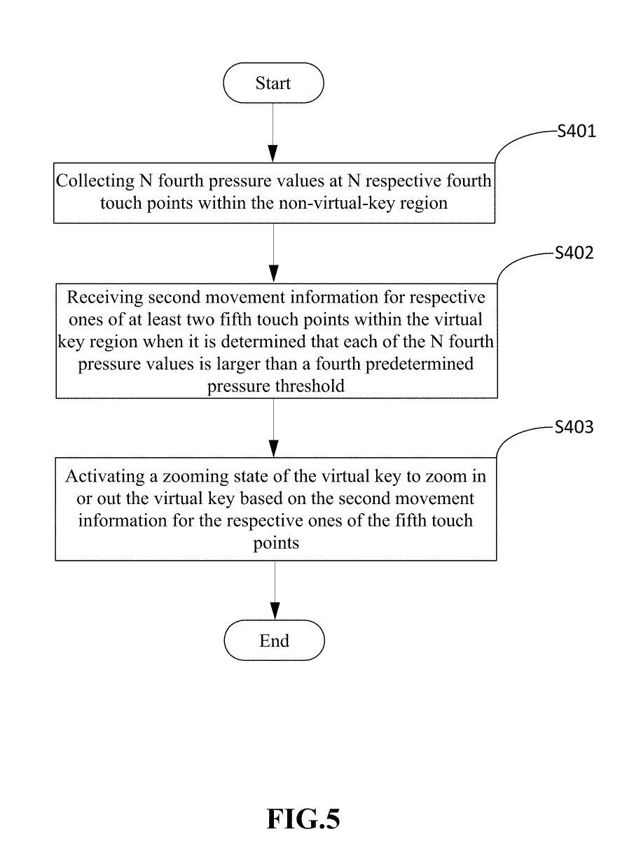

A fourth embodiment of the present disclosure relates to a method for adjusting a virtual key of a mobile terminal. As shown in FIG. 5, the method includes the following steps.

At S401, N fourth pressure values at N respective fourth touch points within the non-virtual-key region are collected.

In particular, in the step S401, force sensors can be provided at four corners of the screen of the mobile terminal for sensing pressures and providing action feedbacks at three levels: tap, soft press and hard press.

At S402, when it is determined that each of the N fourth pressure values is larger than a fourth predetermined pressure threshold, second movement information for respective ones of at least two fifth touch points within the virtual key region is received.

In particular, in the step S402, when there are for example two fifth touch points within the virtual key region, after determining that each of the N fourth pressure values is larger than the fourth predetermined pressure threshold, the mobile terminal will record the second movement information for the respective ones of the two fifth touch points once a gesture detector detects that the two fifth touch points move up and down with respect to each other within the virtual key region.

It is to be noted here that the gesture detection is a process for categorizing a trajectory in a model parameter space into a subset of the space, including static gesture recognition and dynamic gesture recognition which can be converted into the static gesture recognition eventually. From the perspective of technical implementation of the gesture detection, commonly gesture detection schemes include template matching, neural networks and hidden Markov models.

At S403, a zooming state of the virtual key is activated to zoom in or out the virtual key based on the second movement information for the respective ones of the fifth touch points.

In particular, in the step S403, the virtual key can be zoomed in or out in the following manner. Assuming that, at the beginning of the zooming process, the coordinates of the two touch points are P₁(X₁, Y₁) and P₂(X₂, Y₂), respectively, the distance between the two touch points is D₁=\sqrt{(X₁−X₂)²+(Y₁−Y₂)²}. At some time instant during the zooming process, the coordinates of the two touch points become P₁^{⋅}(X₁^{⋅}, Y₁^{⋅}) and P₂^{⋅}X₂^{⋅}, Y₂^{⋅}) and the distance between the two touch points becomes D₁′=\sqrt{(X₁′−X₂′)²+(Y₁′−Y₂′)²}. At this time, the zooming ratio is D2/D1. The zooming ratio changes as the gesture position changes continuously.

When compared with the related art, in the embodiment of the present disclosure, by collecting first touch information within the non-virtual-key region, determining whether the first touch information satisfies a first predetermined adjustment condition and receiving second touch information within the virtual key region, when detecting a touch point within the virtual key region, the mobile terminal will not blindly respond to the virtual key touch operation immediately. Only when a user has performed a particular operation in the non-virtual-key region, the second touch information within the virtual key region can be received and the user can continue operating in the virtual key region. The user cannot adjust the virtual key by operating in the virtual key region directly. In this way, it is possible to effectively prevent false triggering of the virtual key when the user touches the virtual key unintentionally.

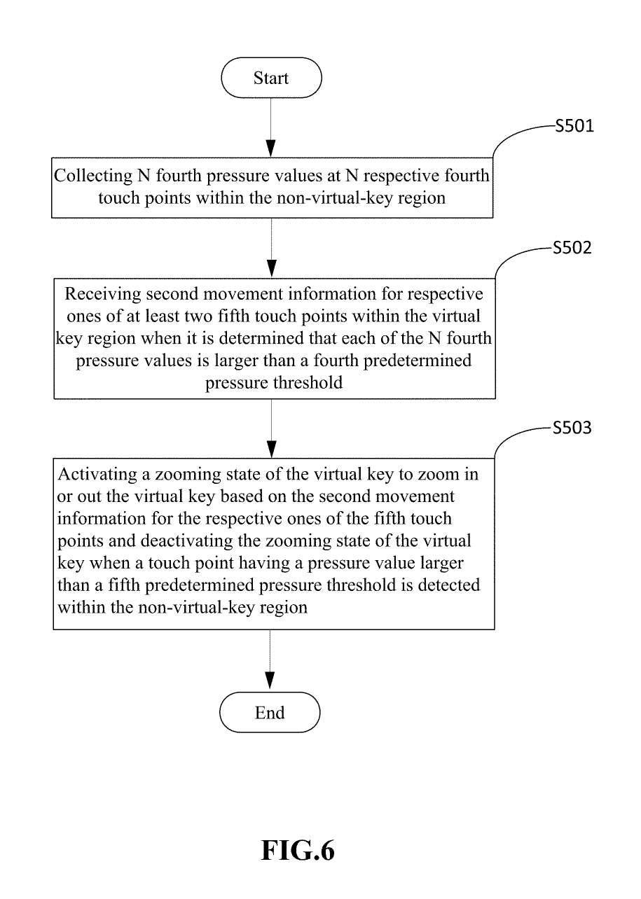

A fifth embodiment of the present disclosure relates to a method for adjusting a virtual key of a mobile terminal. The fifth embodiment makes improvements on the fourth embodiment in that the method further includes, subsequent to zooming in or out the virtual key: determining whether a touch point having a pressure value larger than a fifth predetermined pressure threshold is detected within the non-virtual-key region; and deactivating the zooming state of the virtual key when the touch point having the pressure value larger than a fifth predetermined pressure threshold is detected. As shown in FIG. 6, the method includes the following steps.

At S501, N fourth pressure values at N respective fourth touch points within the non-virtual-key region are collected.

At S502, when it is determined that each of the N fourth pressure values is larger than a fourth predetermined pressure threshold, second movement information for respective ones of at least two fifth touch points within the virtual key region is received.

The steps S501˜S502 in the fifth embodiment are substantially the same as the steps S401˜S402 in the fourth embodiment and details thereof will be omitted here for simplicity.

At S503, a zooming state of the virtual key is activated to zoom in or out the virtual key based on the second movement information for the respective ones of the fifth touch points. The zooming state of the virtual key is deactivated when a touch point having a pressure value larger than a fifth predetermined pressure threshold is detected within the non-virtual-key region.

In particular, in the step S503, by touching the non-virtual-key region again after the user has zoomed in or out the virtual key to an appropriate size, the zooming state of the virtual key can be deactivated immediately when the touch point having the pressure value larger than the fifth predetermined pressure threshold is detected within the non-virtual-key region, such that the virtual key can be zoomed precisely to a size desired by the user.

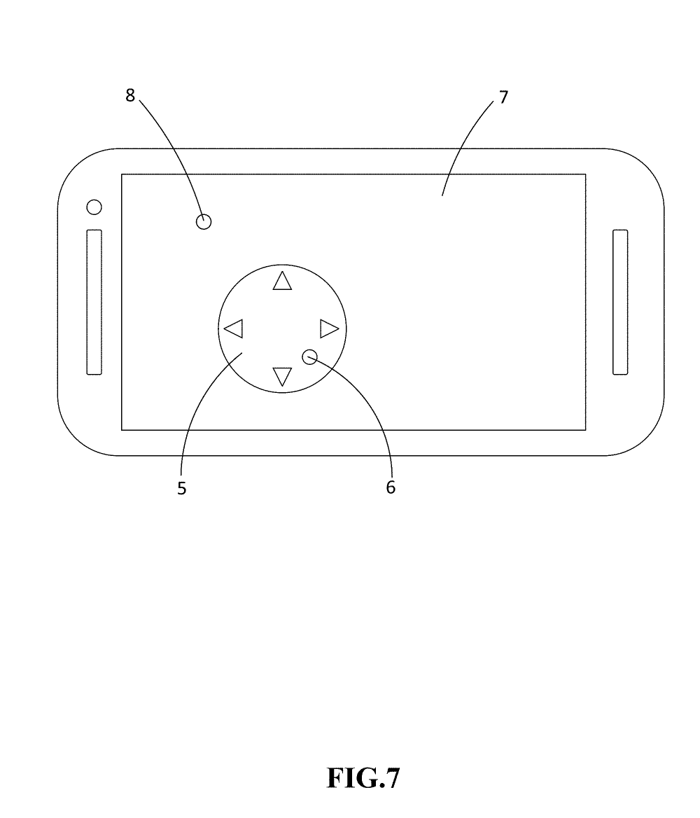

In order to facilitate better understanding of the present disclosure, an example will be given below to explain a method for adjusting a virtual key when the fourth predetermined pressure threshold and the fifth predetermined pressure threshold are equal in this embodiment, as shown in FIG. 7.

(1) The screen is double-clicked. The screen detects a double-click event within the non-virtual-key region and detects that the fourth pressure value of each click reaches the fourth predetermined pressure threshold: the fourth pressure value P_{c1}>=the fourth predetermined pressure threshold Pᵥ. The size zooming state of the virtual key 5 will be activated, waiting for a zooming instruction.

(2) Once the gesture detector detects that two touch points 6 move up and down with respect to each other within the region of the virtual key 5, the virtual key 5 will be zoomed in or out as a whole depending on the distance and direction of the relative movement between the two touch points 6. In particular, the zooming ratio can be calculated as follows. Assuming that, at the beginning of the zooming process, the coordinates of the two touch points 6 are P₁(X₁, Y₁) and P₂(X₂, Y₂), respectively, the distance between the two touch points 6 is D₁=\sqrt{(X₁−X₂)²+(Y₁−Y₂)²}. At some time instant during the zooming process, the coordinates of the two touch points 6 become P₁^{⋅}(X₁^{⋅}Y₁¹⁰⁸) and P₂^{⋅}(X₂^{⋅}, Y₂^{⋅}) and the distance between the two touch points 6 becomes D₁′=\sqrt{(X₁′−X₂′)²+(Y₁′−Y₂′)²}. At this time, the zooming ratio is D2/D1. The zooming ratio changes as the gesture position changes continuously.

(3) After the zooming has completed, another double-click is performed within the non-virtual-key region 7 (the pressure value at the double-click point 8 for each click reaches the fifth predetermined pressure threshold: P_{c1}>=Pᵥ). The zooming state of the virtual key 5 will be deactivated and the current size will be fixed.

When compared with the related art, in the embodiment of the present disclosure, by collecting first touch information within the non-virtual-key region, determining whether the first touch information satisfies a first predetermined adjustment condition and receiving second touch information within the virtual key region, when detecting a touch point within the virtual key region, the mobile terminal will not blindly respond to the virtual key touch operation immediately. Only when a user has performed a particular operation in the non-virtual-key region, the second touch information within the virtual key region can be received and the user can continue operating in the virtual key region. The user cannot adjust the virtual key by operating in the virtual key region directly. In this way, it is possible to effectively prevent false triggering of the virtual key when the user touches the virtual key unintentionally.

The above methods are divided into steps for the purpose of illustration only. In some implementations, some steps can be combined into one step or one step can be divided into several steps. As long as they involve the same logical relationship, they are to be encompassed by the scope of the present disclosure. Some irrelevant modifications or designs can be introduced to the algorithms or processes, without changing their essences. The resulting algorithms or processes are to be encompassed by the scope of the present disclosure.

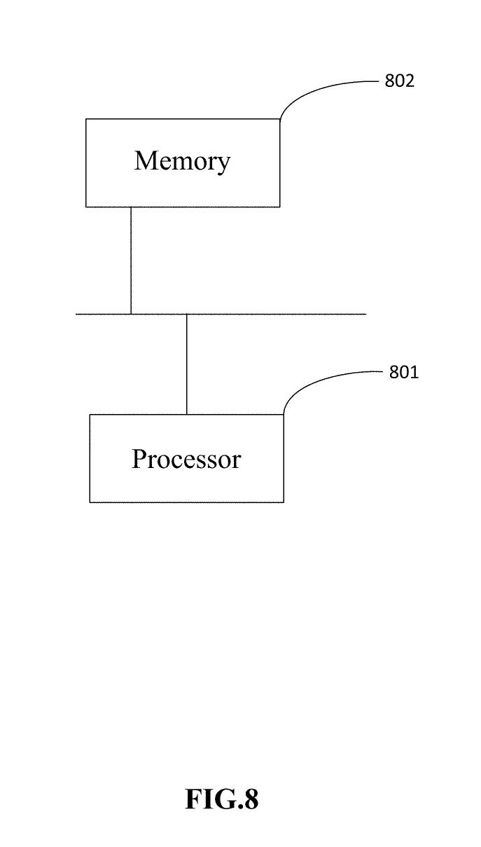

A sixth embodiment of the present disclosure relates to an apparatus for adjusting a virtual key of a mobile terminal. As shown in FIG. 8, the apparatus includes at least one processor 801 and a memory 802 connected communicatively to the at least one processor 801. The memory 802 stores instructions executable by the at least one processor 801. The instructions, when executed by the at least one processor 801, cause the at least one processor 801 to perform any of the methods for adjusting a virtual key of a mobile terminal according to the above embodiments.

Here, the memory 802 and the processor 801 can be connected via a bus which may include any number of interconnected buses and bridges. The bus connects various circuits of the one or more processors 801 and the memory 802. The bus can also connect various other circuits such as peripherals, voltage stabilizers and power management circuits. These are known in the related art and the details thereof will be omitted here. A bus interface can provide an interface between the bus and a transceiver, which can be one or more elements, e.g., receivers and transmitters, for communicating with various other apparatuses via a transmission medium. Data that has been processed by the processor 801 can be transmitted via antennas over a radio medium. The antennas may further receive data and transfer the data to the processor 801.

The processor 801 is responsible for managing the bus and general processes. It can also provide various functions such as timing, peripheral interfacing, voltage regulating, power managing and other control functions. The memory 802 can be used to store data to be used by the processor 801 when performing operations.

It can be appreciated by those skilled in the art that, while the specific embodiments of the present disclosure have been described above, various modifications can be made in practice in forms and details, without departing from the spirit and scope of the present disclosure.

What is claimed is:

1. A method for adjusting a virtual key of a mobile terminal, the mobile terminal comprising a touch screen having a virtual key region with the virtual key and a non-virtual-key region, the method comprising:
collecting first touch information within the non-virtual-key region;
determining whether the first touch information satisfies a first predetermined adjustment condition;
receiving second touch information within the virtual key region when it is determined that the first touch information satisfies the first predetermined adjustment condition; and
adjusting the virtual key based on the second touch information.

2. The method as described in claim 1, wherein the first touch information comprises a first pressure value at a first touch point within the non-virtual-key region, and
the first predetermined adjustment condition comprises the first pressure value being larger than a first predetermined pressure threshold.

3. The method as described in claim 1, wherein the second touch information comprises first movement information of a second touch point within the virtual key region, and
said adjusting the virtual key based on the second touch information comprises:
activating a moving state of the virtual key to control the virtual key to follow movement of the second touch point based on the first movement information, such that a moving trajectory of the virtual key is consistent with that of the second touch point.

4. The method as described in claim 3, further comprising, prior to adjusting the virtual key based on the second touch information:
detecting whether the second touch information satisfies a second predetermined adjustment condition,
wherein said adjusting the virtual key based on the second touch information is performed when the second predetermined adjustment condition is satisfied.

5. The method as described in claim 4, wherein the second touch information further comprises a second pressure value at the second touch point, and
the second predetermined adjustment condition comprises the second pressure value being larger than a second predetermined pressure threshold.

6. The method as described in claim 5, further comprising, subsequent to controlling the virtual key to follow movement of the second touch point based on the first movement information:
collecting a third pressure value at the second touch point in real time as the second touch point moves and detecting in real time whether the third pressure value as currently collected is smaller than a third predetermined pressure threshold; and
deactivating the moving state of the virtual key upon detecting that the third pressure value as currently collected is smaller than the third predetermined pressure threshold.

7. The method as described in claim 1, wherein the first touch information comprises N fourth pressure values at N respective fourth touch points within the non-virtual-key region, where N is a natural number larger than 1, and
the first predetermined adjustment condition comprises each of the N fourth pressure values being larger than a fourth predetermined pressure threshold.

8. The method as described in claim 7, wherein the second touch information comprises second movement information for respective ones of at least two fifth touch points within the virtual key region, and
said adjusting the virtual key based on the second touch information comprises:
activating a zooming state of the virtual key to zoom in or out the virtual key based on the second movement information for the respective ones of the at least two fifth touch points.

9. The method as described in claim 8, further comprising, subsequent to zooming in or out the virtual key:
determining whether a touch point having a pressure value larger than a fifth predetermined pressure threshold is detected within the non-virtual-key region; and
deactivating the zooming state of the virtual key when the touch point having the pressure value larger than a fifth predetermined pressure threshold is detected.

10. An apparatus for adjusting a virtual key of a mobile terminal, comprising:
at least one processor; and
a memory connected communicatively to the at least one processor, wherein the memory stores instructions executable by the at least one processor, the instructions, when executed by the at least one processor, causing the at least one processor to perform the method according to any of claim 1.
